(19) United States
(12) Patent Application Publication
(10) Pub. No.: US 2009/0096306 A1
(43) Pub. Date: Apr. 16, 2009

(54) Auto-generating electric generator

(76) Inventor: Khaled Saied Madny, Kena (EG)

Correspondence Address: ABBOTT FLEUR, 100 HICKORY LANE, BEDFORD, NY, 10506, US

(21) Appl. No.: 11/919,084

(22) PCT Filed: Apr. 20, 2005
(86) PCT No.: PCT/EG2005/000013

§ 371 Date: Oct. 18, 2007

(30) Foreign Application Priority Data
Apr. 19, 2005 (EG) 2005040201

(51) Int. Cl. H02K 47/20; H02K 53/00

(52) U.S. Cl. 310/113; 415/916

(57) ABSTRACT

Generator, motor, closed circuit surplus and overcoming the lost and gained power.

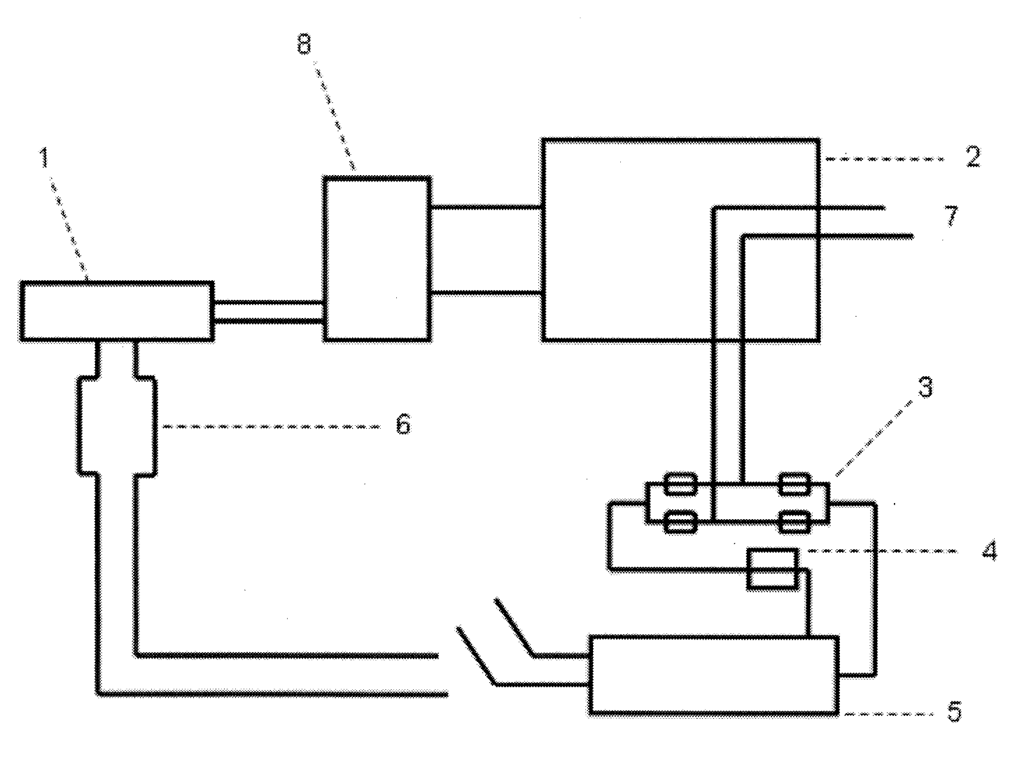

Then the electrical dose comes out of the generator on the unifiers and then to the storing unit and then to the oscillator to prevent reconciliation between the generator and the engine, and vice versa and then attending to the engine and then the engine gives motion to the generator and the generator gives motion to the engine and it remains an exchangeable operation and then the katawet is put between the battery and unifiers to control the stream attending on the battery and engine.

### TECHNICAL FIELD

This invention relates to the cancellation of energy with all its types Energy generator without any external power

A system that may raise the Amber without affecting the Volt Auto power generator or an appliance that may generate power from nothing.

### BACKGROUND ART

Not available

### DISCLOSURE OF THE INVENTION

First the more the poles are in the engine, the more the repulsive electricity becomes and the less the power of magnetic length becomes. This is justified by the fact that the engine that has two poles is more powerful than that with four poles. If the two poles engine is as fast as the four poles engine by the reduction of 300 to 150. After that if we compute the power of the two engines, we shall find that the engine that was reduced in swiftness is more powerful than the engine whose power is 150, taking into consideration that the two engines have equal capacities, let us say KW4.

Second: the engine generating on 150 coils velocity, the repulsion between its poles raises than that which generates on 300. Thus the repulsion increases between its poles. The more the repulsion becomes, the less its magnetic length is, hence, it may be run by half the capacity, let's say 300 coils with the full power of the engine.

So, we may deduct that when the number of poles in the generator is many, it gives higher current and becomes easily run because the raise in repulsion in the poles reduces the rotation velocity and force.

First: bring an engine generating on 10 coils/minute with 100 KW′ power for example.

Second: bring KW4 engine, 300 coils. Then, reduce its velocity to 10 coils/minute by a gearbox to the effect that its velocity becomes 10 coils. Thus the velocity is reduced to the theoretical power which the power of the current.

The number of the engine coils/the number of generator coils

The finding X the basic power of the engine the power of the current resulting—the engine basic power.

300/10=30. Then the power of the engine when generating is =30×4=120 kW, taking into consideration that the power of the engine is 100 kW and the power consumed by the engine in its circuit is KW4 which is the basic power of the engine.

Thus the surplus is 69 kW in excess and 20 kW in excess in the power because the engine, after reduction, becomes 120 kW.

We take into consideration the account of the current loss in the engine and circuiting loss in the engine is 10% at loading in some cases.

Third: I place the current standardizations, i.e., the Silicones because there should be a store unit between the engine and the motor, such unit shall prevent the compatibility between the generator and the engine. If it is supposed that we operated the generator. which would derive its motion from the engine, then the generator needs motion, in the meantime, the engine needs electricity. Thus, the compatibility lakes place. They shall stop in less than a second. The store Unit may keep the battery on 2 or 3′ vase, or 12 volt or 220 volt by connecting many batteries successively f the store unit is 12 volt, the voltage must be reduced to 12 then raised once again from 12 to 220.

Afterwards, I place a current vibrator then I let the current into the engine.

Fourth: the cutouts organize the Amber because the store units are tinseled even if a charger other than the engine tonsils the Amber according to loading.

the new idea in the invention subject/the utility model: The subject of the invention is not a modification occurring on the engines, but it is a new unique engine (auto generator that needs no external power).

It needs no external supply of fuel, power, steam, thermal power or an other type of energy)

Clean and environment friendly.

It can be used everywhere and under any condition.

It can be easily controlled and dealt with.

It renders high power.

This engine is used for every aspect in life, with all car types and engine types.

In the lightening stations where the stations stay without any external power. Using one model after that raise it to 100 Mega or as I wish. The car using such engine stay as a moving light station when it stops. Then, there is the petrol consumption cancellation from the practical life in all its types.

### BRIEF DESCRIPTION OF THE DRAWING

The explanation of the chart and its elements if the store unit is 220:
1. engine
2. generator
3. standarizers
4. Cutouts
5. store units DC
6. vibrator
7. the exit of the current in surplus.
8. gearbox is tearing the engine speed to power with percentage to 30:1 or to 3000:10 or to 3000:100 or to 3000:1500

In case The store unit is 12 volt together with the excess of the following:

1. a reducing transformer as we mentioned above

2. raising transformer DC.

1. (canceled)

2. (canceled)

3. (canceled)

4. (canceled)

5. (canceled)

6. (canceled)

7. (canceled)

8. (canceled)

9. An electrical generator having improved efficiency for feeding a load comprising:
a. an electric AC motor with a rotary shaft output, said motor having two poles
b. a speed reducing gearbox coupled to the Motor,
c. an electric generator coupled to the gearbox with 1^{st} and 2^{nd} power outputs and having four poles,
d. a rectifier for receiving the first output and converting the output to DC wherein the second output is fed to the load,
e. a DC battery having an output for storing the rectifier output,
f. an on/off switch controlling current flow to the battery,
g. a DC-AC converter for receiving power from the battery output energizing the motor;
wherein the generator efficiency is improved because of the reduced number of poles.

10. An electrical generator according to claim 9 wherein said gear box reduces speed by about 30 to 1.

11. An electrical generator according to claim 9, wherein said gear box reduces speed by about 300 to 1.

12. An electrical generator according to claim 9, wherein said gear box reduces speed by about 2 to 1.

13. A method for operating an electric generator at improved efficiency using a speed reducing gearbox, said method comprising the steps of;
a. driving an AC generator through an output of the gearbox;
b. driving an input to the gearbox by an electric motor;
c. rectifying an output of the generator;
d. feeding an output of the generator to a load;
e. storing a rectified output of the generator in a battery;
f. converting the output of the battery to a current suitable for driving the motor;
whereby the generator efficiency is improved by the use of the speed reducing gearbox which reduces the speed of the generator to be less than that of the electric motor.
